(19) United States
(12) Patent Application Publication
(10) Pub. No.: US 2007/0083302 A1
(43) Pub. Date: Apr. 12, 2007

(54) Object locating arrangements, and in particular, aircraft geometric height measurement arrangements

(76) Inventor: Louis C. Delemarre, Galloway, NJ (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/543,911

(22) Filed: Oct. 6, 2006

Related U.S. Application Data
(60) Provisional application No. 60/724,286, filed on Oct. 7, 2005.

(51) Int. Cl. G06F 19/00

(52) U.S. Cl. 701/14; 701/207

(57) ABSTRACT

A data-gathering unit for gathering data for determining a location of an object, including: a receiver to receive predetermined data from the object, and a universal coordinated time (UTC) data from an orbital system, and to time-stamp sub-portions of the predetermined data using the UTC derived from the orbital system as a base time.

### CROSS-RELATED APPLICATION(S)

This non-provisional application claims priority from U.S. provisional application 60/724,286 filed Oct. 7, 2005. All content and teachings of the above application are incorporated herein by reference.

### FIELD

The present invention relates generally to object locating arrangements, and relates more specifically to aircraft altitude detection, e.g., a ground-based system/technique to determine location (e.g., geometric height) of an aircraft's altitude.

### BACKGROUND

Although background discussions and example embodiments of the invention are described utilizing the example of aircraft altitude detection, practice of the present invention is not limited thereto. That is, the present invention may be practiced to determine location of any type of object.

In beginning discussion, an in-flight aircraft (e.g., within USA territories) is required by the Federal Aviation Administration (FAA) to maintain a minimum vertical separation from other in-flight aircraft. Minimum vertical separation is for the purpose of avoiding in-flight collisions between aircraft. An aircraft's required vertical separation is dependent upon a flight level (FL) that that aircraft has been assigned by air traffic control.

In an effort to gain fuel saving and increase airspace capacity, it is desired to reduce allowable vertical separation requirements for aircraft, while at the same time, maintaining safety and security in the flight space. The Reduced Vertical Separation Minimum (RVSM) program has been developed to institute new minimum separations in both the United States and elsewhere.

A particular benefit, which will accrue from the RVSM, includes cost per flight savings. Fuel burn savings are projected to be approximately $5.3 billion over the eleven-year period between 2005 and 2016, with $393 million in savings in the first year, increasing at a rate of 2 percent per year. This amounts to an approximately 2 percent savings for U.S. domestic air fleet operations. Such fuel burn savings are directly attributable to improved routing, altitude selection, and reduction of delays provided by RVSM.

Another particular benefit is an increased number of available flight levels. In United States domestic airspace, currently a 1,000-foot vertical separation is applied up to FL 290 (i.e., 29,000 feet), and 2,000-foot vertical separation is applied above FL 290. The RVSM program will allow 1,000-foot vertical separation to be applied between FL 290-FL 410 (inclusive). As a result, implementation of the RVSM between FL 290 and FL 410 will add six additional flight levels in airspace, for use.

Other benefits include, but are not limited to, an increased airspace capacity due to enhanced traffic throughput and efficiency within en route airspace, enhanced controller flexibility due to more flight path options for situations such as weather re-routes and crossing traffic, and a diminished effect of traffic converging at critical points in high density traffic areas.

According to FM regulations, aircraft and operators have to be approved for participation in the RVSM program. After approval, because of the criticality of the reduced separation minimums of RVSM, it is desirable to: closely monitor aircraft altitude-keeping in-service performance to identify individual aircraft that are not performing adequately according to RVSM standards, identify any adverse altitude-keeping trends for individual aircraft types, and provide data for use in safety analysis.

Once assigned a flight level by air traffic control, aircraft (flying above a certain predetermined geometric height, for example) mainly utilize the aircraft's pressure altitude altimeter to maintain flight at its assigned flight level. It is assumed generally, that if all RVSM-approved aircraft fly at their assigned flight levels using properly calibrated/operating pressure altitude altimeters, then aircraft will maintain proper minimum separation distances from one another so as to avoid any in-flight collision.

That is, it is critically important that pressure altitude altimeters of RVSM-approved aircraft maintain calibration over time, and accordingly, it is important that the pressure altitude altimeters of RVSM-approved aircraft be monitored on occasion. Altimeter system error (ASE) is one major component of aircraft altitude-keeping performance. The ASE is the difference between the pressure altitude displayed on an aircraft's altimeter and the true pressure altitude.

One disadvantaged system for monitoring aircraft altitude-keeping performance is an on-board Global Position System Monitoring System (GMS). The GMS, which has been used since 1996, is a special-purpose data collection system which is carried aboard an aircraft for one flight by a specially trained operator, during which the unit collects Global Positioning System (GPS) pseudo-ranges, secondary surveillance radar Mode C data, and metrological data. To ensure collection of sufficient position data the aircraft must fly straight and level at any altitude from FL290 to FL 410 for at least thirty minutes in duration. Post-flight processing of this data ensures estimates of aircraft geometric height which are of sufficient accuracy to permit estimation of relevant height-keeping performance parameters, including ASE, Total Vertical Error (TVE), and Assigned Altitude Deviation (MD).

The on-board GMS, while providing information necessary for proper monitoring, has drawbacks which make its use undesirable. For example, use of the GMS is very labor intensive, which may be costly to aircraft operators. Also, special arrangements have to be made to schedule a flight with the data collection system. Further, due to increased security measures, it is difficult to obtain approval to place the data collection system, along with its operator, in an aircraft.

Accordingly, in the realm of aircraft control/monitoring, a need exists for an improved altitude-keeping in-service performance monitoring technique which overcomes the above deficiencies.

Before continuing further discussions, know art of interest, may include:
UK Patent Application GB 2 250 154 A, having the inventive entity Bent et al, and published May 27, 1992;
U.S. Patent Application Publication U.S. 2002/0011948 A1, having the inventive entity of Weedon et al., and published Jan. 31, 2002;

U.S. Patent Application Publication U.S. 2003/0156498 A1, having the inventive entity of Weedon et al., and published Aug. 21, 2003;

U.S. Pat. No. 4,215,345, issued to Frosch et al., on Jul. 29, 1980;

U.S. Pat. No. 5,940,035, issued to Geoffrey S. M. Hedrick, on Aug. 17, 1999;

U.S. Pat. No. 6,222,487 B1, issued to Ahlbom et al., on Apr. 24, 2001;

U.S. Pat. No. 6,424,293 B2, issued to Weedon et al., on Jul. 23, 2002;

U.S. Pat. No. 6,587,079 B1, issued to Rickard et al., on Jul. 1, 2003;

U.S. Pat. No. 6,650,597 B2, issued to Weedon et al., on Nov. 18, 2003;

All content and teachings of all of the above art are incorporated herein by reference.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a simplified depiction of an example aircraft geometric height measurement element constellation, in accordance with certain aspects of the present invention.

FIG. 2 is a simplified depiction of an example Mode S subsystem of an element of FIG. 1, in accordance with certain aspects of the present invention.

FIG. 3 is a flow chart depicting example operations performed by the example Mode S subsystem, in accordance with certain aspects of the present invention.

FIG. 4 is an example system overview of example elements of the FIG. 1 example embodiment, in accordance with certain aspects of the present invention.

FIG. 5 is an example system overview of another embodiment, in accordance with certain aspects of the present invention.

FIG. 6 is an example hardware interconnect diagram of an example embodiment of the present invention, in accordance with certain aspects of the present invention.

FIG. 7 is an example satellite dish embodiment of the present invention, in accordance with certain aspects of the present invention.

FIG. 8 is an example flow diagram, in accordance with certain aspects of the present invention.

FIG. 9 is an example representative view for explaining problems encountered with an embodiment of the present invention.

FIG. 10 is an example representative view for explaining an operation and advantages with respect to an example satellite dish embodiment of the present invention.

FIG. 11 is an example representative view, useful in an explanation of operations/advantages of the present invention.

### DETAILED DESCRIPTION

Before beginning a detailed description of the subject invention, mention of the following is in order. When appropriate, like reference numerals and characters may be used to designate identical, corresponding or similar components in differing FIG. drawings. Further, in the detailed description to follow, example sizes/models/values/ranges may be given, although the present invention is not limited to the same. As a final note, well known power/ground/data connections to blocks/ICs and other components may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. In other instances, detailed descriptions of well-known methods and components are omitted so as not to obscure the description of the invention with unnecessary/excessive detail. Where specific details (e.g., circuits, flowcharts) are set forth in order to describe example embodiments of the invention, it should be apparent to one skilled in the art that the invention can be practiced without, or with variation of, these specific details. Finally, it should be apparent that differing combinations of hard-wired circuitry and software instructions can be used to implement embodiments of the present invention, i.e., the present invention is not limited to any specific combination of hardware and software.

As mentioned previously, although example embodiments of the invention are described utilizing the example of aircraft altitude detection, practice of the present invention is not limited thereto. That is, the present invention may be practiced to determine location of any type of object.

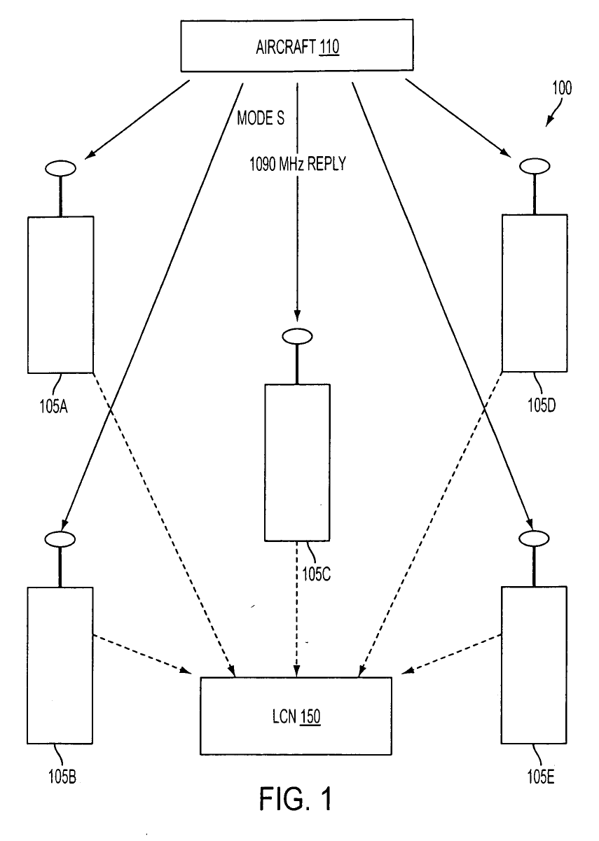

One example system for altitude-keeping in-service performance monitoring which overcomes the deficiencies of on-board disadvantaged monitoring systems is an Aircraft Geometric Height Measurement Element (AGHME) constellation 100 shown in FIG. 1. The AGHME has been developed by the USA's Federal Aviation Authority (FAA) Technical Center. The constellation 100 may consist of five identical elements 105A-105E (acting as data-collecting (DCol) or height monitoring unit (HMU) receivers), for example, strategically placed along busy jet routes where aircraft are expected to travel in straight and level flight. The elements 105A-105E do not have to be in line-of-sight with one another. Presently, it is estimated that five such constellations 100 geographically disbursed across the USA may provide adequate monitoring of aircraft traffic within the USA.

In beginning to look at particulars, an element 105 may be passive in nature and radiate no energy in the operational frequencies of the aviation community, and therefore may be easily/safely placed at FAA operated facilities with no danger of inducing interference into neighboring sensitive equipment. In contrast, if an element 105 is found itself to be sensitive to energy, noise, interference, etc., from neighboring equipment, then the element 105 may be positioned at a differing site which is free of such energy, noise, etc., or else precautions (e.g., shielding, insulation) may be provided to the element 105 in order to provide protection thereto.

Continuing discussion, each data-collecting element 105 may be adapted with the appropriate hardware/software, etc., to monitor for the data of interest. For example, with the present non-limiting example, the element 105 may monitor for data/signals within a 1090 MHz environment that contains existing Mode A, Mode C and Mode S communication information packets transmitted from an airframe 110. In an example embodiment (described herein), an element 105 may capture/utilize the Mode S transmissions, but practice of the present invention certainly is not limited thereto. That is, as desired, Mode A and Mode C transmissions could also be captured/utilized, or any combination of Mode A, Mode C and Mode S transmissions may be used. A differing type of transmission other than Mode A, Mode C and Mode S transmissions may alternatively be captured/used.

In jumping ahead, ultimately, each element 105 may forward raw data sets to a designated master processor or Logical Central Node (LCN) 150 for processing to determine altitude-keeping in-service performance, i.e., a target airframes' in-flight geometric height. The raw data may be compiled/stored at the LCN (e.g., within appropriate memory), and may be either instantaneously or periodically processed.

While an example five elements 105A-E are illustrated/described with respect to the example embodiment, practice of the present invention is not limited to such number of elements. For example, more than five elements may be provided, albeit costs may be a consideration. In addition, as one example, the five elements 105 may be geographically disbursed from each other in a diamond or cross pattern, although practice of the present invention is not limited thereto. One example separation distance between elements may be 40-50 miles; again, practice of the present invention is not limited thereto. The separation distances between various pairs of the elements 105 do not have to exactly match each other; thus, there is flexibility in applying each of the elements 105A-E to geographically convenient locations.

Since the exact geographical locations of the elements 105 (e.g., the antennas or dishes thereof) with respect to each other (and the earth) may be known and utilized within calculations, the exact (unknown) position and altitude of an aircraft may be determined (e.g., on a basis of complex triangulation-like calculations) on a basis of the time differences taken for signals from the aircraft transponder to reach each of the elements 105A-E. That is, raw data particular to an aircraft of interest (AOI) may be collected at each of the data-collection elements 105A-E, and then compiled/processed within the LCN (or elsewhere) to obtain a substantially accurate position and altitude reading for the AOI. An LCN 150 may be housed, as desired, at one of the elements 105A-105E, or may be housed at a differing location.

In providing even greater details, each element 105 may include three subsystems that work in unison to generate the raw data (discussed above) that is forwarded to the LCN. The three subsystems may include, for example, a data-capturing subsystem (e.g., a Mode S subsystem), a timestamp subsystem and a communication subsystem. Example (i.e., non-limiting) embodiments of these subsystems, including certain alternatives thereof, will be described further below.

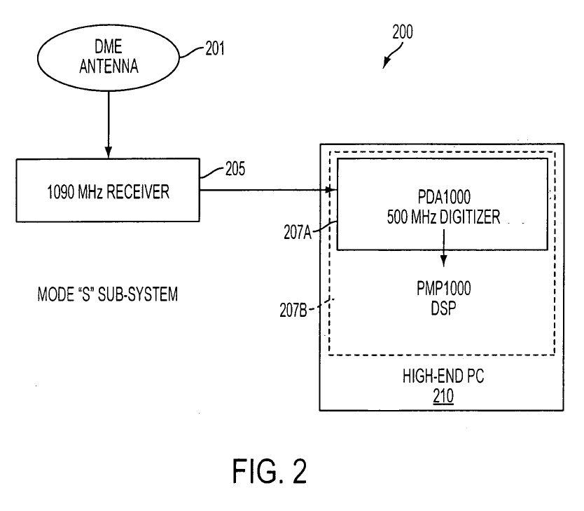

FIG. 2 is a simplified depiction of an example Mode S subsystem 200. There may be included a 1090 MHz antenna 201 (e.g., distance measuring equipment (DME) antenna) which may be designed for use with a ground-based station. Antenna 201 may have a pattern that has a large gain along the horizon, since most of the airframes 110 which will be monitored may typically be within the first ten to fifteen degrees above the horizon. Antenna 201 may also be designed to diminish multi-path phenomena (that may cause an element 105 to select a ground based reflected signal from an airframe 110 instead of a direct line-of-sight airframe-to-element transmission). A received 1090 MHz signal may be coupled from the antenna 201 to a 1090 MHz receiver 205. Receiver 205 may demodulate the 1090 MHz carrier wave, and may output a video pulse stream that contains Mode A, Mode C, and Mode S data.

The output video pulse stream may then be fed, for example, to a tandem set of PCI based units (e.g., boards) 207A, 207B that process the data stream and provide the raw data sets that are ultimately used (by the LCN 150) to calculate the geometric height of target aircraft. The raw data set may be of any predetermined data structure definition, and may contain, for example, all or a subset of the members listed below depending on message type: the aircraft ID, the message type, the pressure altitude of the aircraft, the time of arrival of the Mode S message, and the signal amplitude of the message used in a matching algorithm, to be discussed further below. As desired, or as known to those skilled in the art, other parameters may also be included in a raw data set. For example, each message may contain its own unique message identification data, e.g., a unique sequential message number.

Ultimately, extracted data sets may be used (e.g., in the logical central node 150) in a matching algorithm having a goal to find/produce a quintuplet set of data, all pertaining to a same S message but received at the five elements 105A-105E. Extracted quintuplet sets may then be combined with other quintuplet sets for the same aircraft 110 and placed in a data output file that may be called a “track file”. A track file may then be utilized by a height generation model, whereupon a geometric height (of the aircraft's travel path through the constellation's monitoring volume/area) may be computed for this aircraft 110.

Returning back to the processor discussion, boards 207A, 207B may reside in a processor apparatus 210 that may constitute the processing nucleus of each element 105. The processor 210 may be a high-end PC that runs, for example, a Linux based operating system. A state-of-the-art board set may include an oscilloscope card (digitizer) 207A that digitizes the video pulse stream. Such digitization may take place, for example, at a rate of 500 Mega-samples per second, resulting in an example time resolution of 2 nanoseconds per sample. The digitizer 207A may contain, for example, 500 Mbytes of Ram memory so as to allow message data with respect to a one second capture time (i.e., window) to be acquired. Of course, a larger sized memory may be provided/utilized to capture a longer window of data.

It may be noted at this point, that if 500 Mbytes of RAM stores 2 nanosecond resolution samples within each memory location and 1 second of sample data in total is stored (for a given data-capture operation), then the memory may be configured such that a memory address of each sample location may be intuitively related to a sample's time-of-receipt time. As one example, assume that a first sample is stored within a first memory location of the memory, and subsequent sequential samples are stored within subsequent sequential memory locations, respectively. If a base time-of-receipt time is captured (and thereafter known) for the sample data stored in the first memory location (within the 500 Mbyte RAM), then a time-of-receipt time of a next sample data stored in the next (i.e., second) memory location may be easily known/calculated, i.e., it will be the base time-of-receipt time plus a 2 nanosecond time increment. Each subsequent memory location would accumulate another 2 nanosecond time increment, with a time-of-receipt of a last memory location being easily known/calculated, i.e., the base time-of-receipt time plus the total 1 second data capture time increment.

Practice of the present invention is not limited to referencing the base time-of-receipt time to the first memory location. For example, the base time-of-receipt time may be captured/stored with respect to a middle memory location, or a last memory location.

In continuing discussions, information output from the digitizer 207A (once captured) may then be passed (e.g., via the intermediary of the RAM memory storage) to the companion board 207B which may be a high speed digital signal processor (DSP). The information may be transferred from the digitizer 207A to the DSP 207B via a private 500 Mbytes per second high speed data bus 208. Alternatively, the digitizer 207A and DSP 207B may be integrally provided as a single unit.

An algorithm residing in the DSP 207B may detect, decode, and timestamp Mode S messages received in the captured digitized data. First, the Mode S messages must be extracted from the intermingled, i.e., mixed Mode A, Mode C, Mode S, captured data.

As one example, since Mode A and Mode C messages may each have a short length/duration (as opposed to Mode S messages which have a longer length/duration, e.g., 64 microseconds), an appropriate filtering arrangement may be applied to the raw 1 second data to eliminate (i.e., filter out) Mode A and Mode C messages, while retaining Mode S messages (of interest with the present example embodiment).

In further detailing the Mode S messages, there are several message types in the Mode S environment, with the present invention leveraging (as a non-limiting example) the unsolicited squitter message type and the message type that contains the pressure altitude of the aircraft. Again, one example normal Mode S message may be 64 microseconds in duration, with an eight microsecond preamble of pulses that identify it uniquely as such. Each Mode S message may also contain a 24 bit unique aircraft identifier that is assigned to each particular airframe. This aircraft identifier may be used by a matching algorithm of the present invention (as one criteria) in processing track files, to be discussed further below.

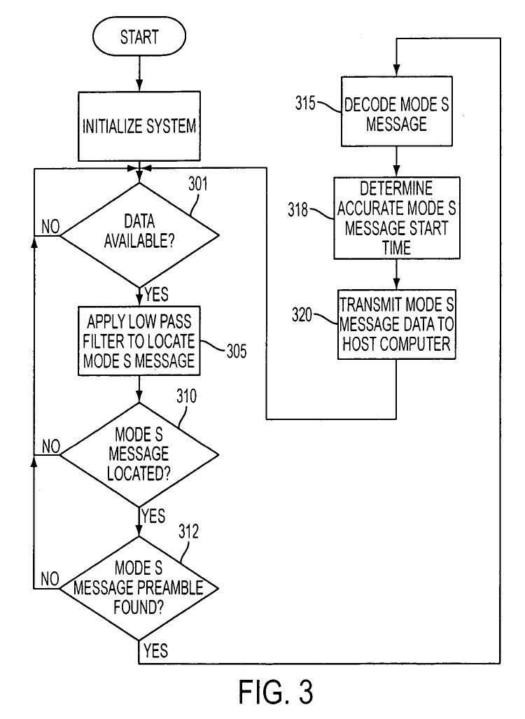

FIG. 3 is a simplified flow depiction of one example processing of the Mode S algorithm (for Mode S message acquisition). As shown, at example step 301, DSP 207B may determine if an incoming data stream (e.g., a video (i.e., digitized) pulse stream) is available. If not, flow may loop (“No” branch) back through step 301. When data becomes available (“Yes” branch), a low pass filter, at step 305, may be applied, for example, to the data to remove (i.e., filter out) the shorter Mode A and Mode C messages and to locate candidate Mode S messages.

At example step 310, a determination may be made (e.g., for a candidate message) to determine if a viable Mode S message has indeed been located. If not, operations may continue (via “No” branch) with step 301. If a potential Mode S message has been located, operations may continue (via “Yes” branch) with example step 312 in which the DSP 207B may determine if an actual Mode S message preamble has been found in the located Mode S potential message. If not (“No” branch), operations continue with step 301.

If a Mode S message preamble has been found (“Yes” branch), operations may continue with example step 315 in which the DSP 207B, for example, decodes the Mode S message. Thereafter, operations may continue with example step 318 in which the DSP 207B determines the start time of the Mode S message, and associates (e.g., attaches) time-stamp data with the Mode S message. Then, at example step 320, the DSP 207B may transmit the time-stamped Mode S data (i.e., predetermined raw data) which will be used to determine aircraft position and/or altitude to the Logical Central Node 150. Thereafter, operations may again continue with step 301 to monitor for a next Mode S message.

In one experimental setup, it took the DSP 207B a little over 7 seconds to process the 1-second body of captured data to derive the Mode S messages. Such DSP data processing/throughput time may be taken into consideration, for a determination as to how often a 1 second window of data should be captured from the object. For example, as slightly over 7 seconds of processing/throughput is needed to process the totality of the 1-second data within the present example, the arrangement may be configured to capture 1 second windows of data intermittently at every 8 or 9 second interval. Of course, practice of the present invention is not limited thereto.

In order for the predetermined raw data from the differing element 105 sites to be useable to accurately determine a location or height of an object (e.g., an aircraft), an accurate time of receipt (at the element 105) of each message must be captured and provided together with respective Mode S messages provided to the Logical Central Node 150. That is, the relative times at the respective elements 105 should be coincided with each other as accurately as possible, such that any time information provided from the differing element 105 sites are coherent with, and meaningful to, each other. Further, during time-stamping operations within each element 105, each Mode S message must be time-stamped with an as-accurate-as-possible time-of-receipt time (using the element 105's relative time clock). Any error in relative times of the respective element 105 sites in comparison with each other, and any error in the captured time-of-receipt for a respective message, ultimately will result in errors in a calculated location or height of an object. In some object locating environments, excessive error may be unacceptable and lead to devastating results. For example, excessive error in the realm of aircraft height detection/monitoring may eventually lead to catastrophic air collisions/disasters.

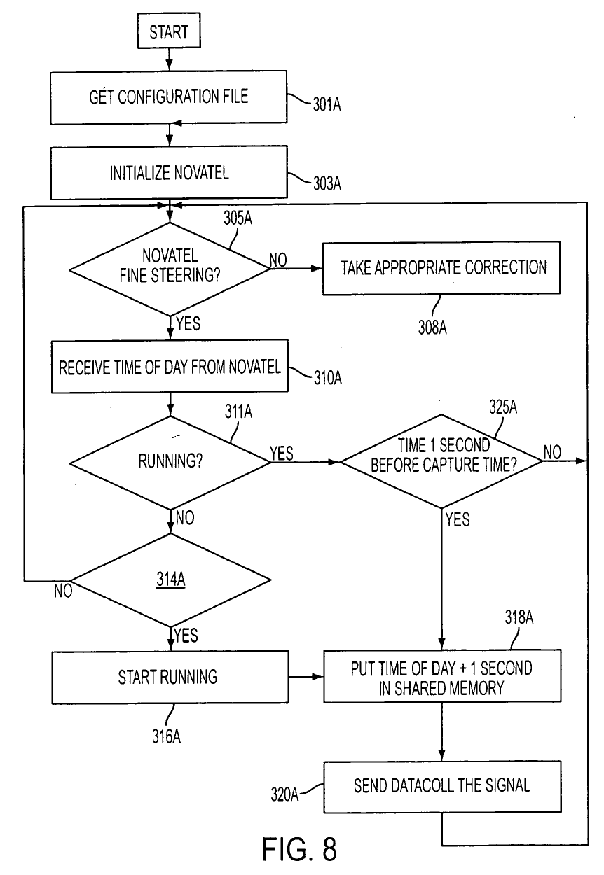

FIG. 8 is an example (advanced) timing mechanism that may allow timing counters/clocks within all five example elements (i.e., data-collecting sites) in the constellation to be substantially in sync with each other. One example piece of hardware that may be responsible for keeping the accurate timing of the elements across the constellation, is the Novatel GPS receiver 410.

As to further details, a very accurate one second pulse may be available every second from the NovAtel GPS receiver 410, and such one second pulse may be provided to the digitizer 207A. Since the DSP board needs (in the present example) a little over seven seconds to analyze the half a gigabyte of data that is captured in a one second snapshot, as mentioned previously, not every one second pulse may be used to start capture with the digitizer 207A. The mechanism that allows the digitizer 207A to start may be, for example, a Linux system signal being sent by FIG. 8's tsproc application (see step 320A) to the data collection or data capturing application.

When the data collection application may be configured such that when it receives this Linux signal, it sends an arm command to the digitizer board 207A and the next one second pulse rising edge is used to start the one second data capture with the digitizer 207A. Such may be a rational that demands the Linux signal be queued on the one second pulse before the capture second. Such one-second lead time may allow for latency issues that exist in a real time multi-tasking environment.

As further discussions, the Novatel 410 may operate more accurately if it knows the exact geographical location of its antenna. For example, such known location may allow algorithms to solve for one unknown, i.e., time, rather than four unknowns, i.e., x, y, z, and time. For availability, the known geographical location of the Novatel's antenna may be put into a predetermined configuration file. The FIG. 8 tsproc application may have the responsibility for accessing (step 301A) the geographical location from the configuration file, and programming the Novatel upon initialization (step 303A) with its antenna location.

Another operation which may be checked (step 305A) before the Novatel's one second pulse may be assumed accurate, is a fine steering operation of the Novatel. Fine steering, in the present discussions, means a check as to whether the NovAtel is correctly frequency-locked with a frequency being supplied by an orbital entity (i.e., GPS and/or WAAS satellites). Such fine steering condition may be checked periodically, e.g., every second, to make sure that the NovAtel never drops out of fine steering (i.e., sync) with the orbital entity. If fine steering is improper (No branch), then appropriate correction may be taken (step 308A).

In addition to receiving a frequency standard from the orbital entity and supplying the same forward to other components, the NovAtel may also periodically receive time of day (e.g. universal coordinated time (UTC)) data (e.g., in the form of day, hour, minute and/or second, etc., from the orbital entity. The NovAtel may then periodically (e.g., every second) supply the time of day forward (step 310A), e.g., via a message, using an example serial port 406. Such UTC data will be shown to be important within alternative embodiments discussed ahead.

After fine steering is acquired and the time of day (UTC) supplied, the processor 210 may check to see if the time of day is on a starting boundary. If the time is on an even starting boundary 314A the AGHME element is placed in a run mode state, all the AGHME Elements 105A-105E should have a common starting time. The decision entity 325A is necessary so that the arming process happens on the second before the capture second. This allows for system latency to be accommodated so that the PDA 207B is armed and ready for the leading edge of the capture second pulse. The time of day may be placed (step 318A) in a shared memory segment between tsproc and datacoll so that a base time can be assigned to the one second Mode S sample set that has just been acquired.

The next thing that may be done (in the present example) is a Linux system signal (step 320A) which is responsible for triggering datacoll to acquire a mode S sample set. The tsproc application will then monitor the time coming from the Novatel and wait for the next appropriate sample time interval 325A defined in the configuration file 301A. When that condition is met we will again store the time in shared memory and send the datacoll application the Linux system signal 318A and 320A. This looping process is continued for the duration of the day and starts again after the system reboot at midnight of each day.

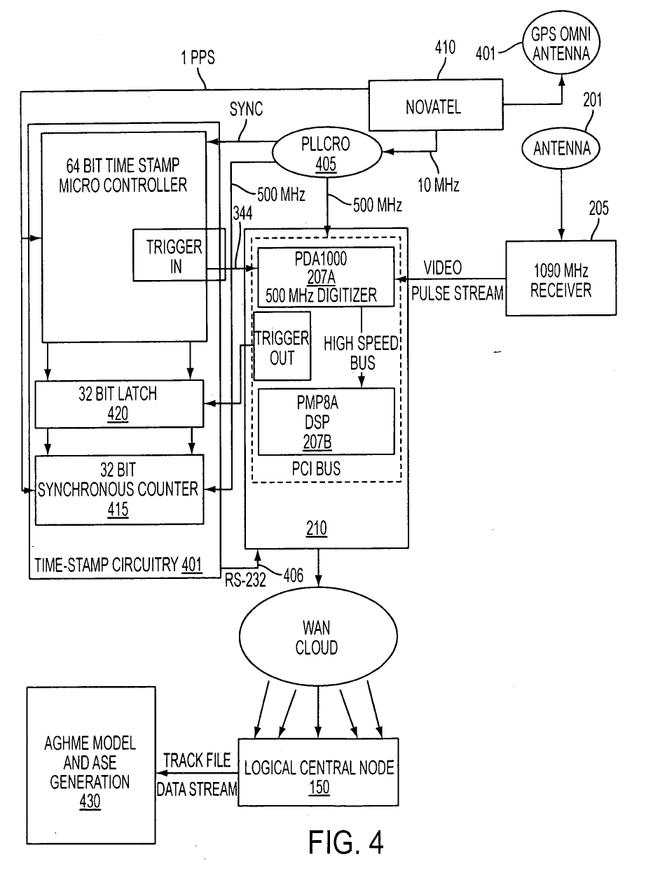

In shifting discussions back to time-stamping within a element 105 site, one example timestamp subsystem 400 is shown in FIG. 4. Such is composed of an example high-speed counter/latch timestamp board 401, phase locked loop coaxial resonator oscillator (PLLCRO) 405 and the Novatel state-of-the-art GPS receiver 410 which includes, for example, a locally trained 10 MHz oscillator. One specific example state-of-the-art GPS receiver is the NovAtel ProPak receiver. The training algorithm for the 10 MHz oscillator may be derived from the GPS community of satellites, and may be further enhanced by Wide Area Augmentation System (WMS) algorithms present in the GPS receiver 410. The GPS receiver 410 may use the 10 MHz signal to establish, for example, a 1 pulse per second (PPS) signal that may be utilizable as the trigger mechanism used throughout the example counter/latch timestamp board 401 described in the present example.

The same 10 MHz signal may also be fed to the PLLCRO 405 which may then utilize the 10 MHz signal to generate/provide a 500 MHz time standard that may be provided to the counter/latch timestamp board 401 and may also be provided as an external time base for the digitizer 207A. Thus, three time references may all be related (i.e., synchronized) to each other, since the 1 PPS and the 500 MHz signals may be derived from the trained 10 MHz reference frequency. The 500 MHz time base and the 1 PPS signal may thus be locked and synchronized to each other because of their intimate relationship with the common 10 MHz reference frequency.

In this example, an example functionality of the counter/latch timestamp board 401 may be to monitor the 1 PPS signal from the GPS receiver 410, and to utilize it to start counter 415 at a desired start time, and to pick selected “trigger seconds” to trigger a sample one second capture in the digitizer 207A. It also may monitor for a sync lost situation with respect to the PLLCRO 405. The timestamp board 401 may be in communication with a timestamp application which resides on the PC 210. The timestamp application may coordinate timestamp activities between the GPS receiver 410, board 401, and the Mode S subsystem 200. This communication may take place via a RS-232 communication port 406 from the NovAtel ProPak receiver. Command streams may flow bi-directionally through the RS-232 port 406 to coordinate activities for desired functionality.

The timestamp board 401 may also monitor a symmetric trigger 462 from the digitizer 207A that indicates, for example, that the digitizer 207A has committed to collecting a 1 second “snapshot” of data of the monitored 1090 MHz environment.

This one second capture may contain the video (i.e., digitized) pulse stream made up of all the Mode A, Mode C, and Mode S messages that occurred during this capture window. This symmetric trigger 462 may cause a hardware latch in the 32 bit latch 420 to latch which may capture a free running count in the 32 bit synchronous counter 415 to within, for example, a two nanosecond resolution. This count may then become a base time for the 1 second snapshot being taken.

This information may be conveyed to the timestamp application that coordinates this data to a Mode S application. The Mode S application may receive decoded Mode S packets from the DSP 207B, and marry this information with the base time from the timestamp application which generates the receipt times for these Mode S messages captured during this example one second window. An application may generate a file (e.g., the file name may be the second count of the day) containing all the decoded messages received for that second which may then be processed to obtain raw data files for transmission to the communication subsystem. The application may also initialize the board set 207A and 207B, and download the runtime code that resides on the DSP board 207B.

The 500 MHz signal may be fed into the 32 bit synchronous counter 415 from the PLLCRO 405. This frequency may be used by the free running counter 415, and may become the relative time standard between the five elements 105A-105E of a constellation 100. Thus, for the first alternative (example) timestamp subsystem of FIG. 4, the GPS community of satellites, via the training algorithm on the local 10 MHz signal at each element 105, may provide a common relative time standard at the five locations 105A-105E. Each element thus theoretically has a free running counter 415 arrangement, which is thus theoretically running at a real-time count which is exactly or reasonably close to real-time counts at the other four elements.

The elements 105A-105E may thus utilize the 500 MHz signal, the counter and the 1 PPS signal to orchestrate the collection of data sets that are ultimately compiled and used to generate geometric height data points.

The communication subsystem may utilize components found on the motherboard of processor 210. A communication application resident on the processor 210 may utilize a socket server/client philosophy to accomplish the transmission of data from an element 105 to the Logical Central Node 150 for that constellation 100. Thus, the element 105 may contain a server application resident on processor 210, and the LCN 150 may contain a client resident on a processor at the LCN 150.

The client, via an example tcp/ip protocol over either an example WAN Cloud or Land Line, may solicit a connection to a server application. The server application may note an ID of the requestor (i.e., client) and establish a connection if, for example, the client has the proper credentials. A known unique packing algorithm may be utilized that makes the most efficient marriage between network packet size and latency of data transmission.

If a situation occurs where network connectivity is temporarily lost, data may be stored locally at a processor 210 in a predetermined directory until connectivity is restored. Preferably, connectivity may be automatically restored, as it becomes available. After restoration, the communication process may detect the presence of stored data in the predetermined directory (which may include data for multiple days, i.e., assuming sufficient memory is available) and may automatically disseminate this older data to the LCN 150 until it has caught up to the present time line.

In the example embodiment, the LCN 150 may have five client applications, i.e., one associated with each ELEMENT 105A-105E, respectively. Each client application may maintain connectivity with the appropriate server, and store received data sets in a designated location. When data sets are stored which represent a predetermined amount of time (such as an entire day), an application resident on the LCN 150 processor may be run that contains a complex algorithm that matches the raw data from the five elements 105A-105E constituting a constellation 100 into matched sets.

This matching algorithm may produce, for example, a matched set of raw data by first ensuring that the aircraft identifier is the same across all raw data. It may also validate that the message type of the Mode S message is the same for the five candidate raw data sets.

At this point, it should be noted that the processed raw data could be from four elements 105, or even a fewer number, instead of five. Also the data may be from elements 105 greater in number than five.

After validation, the matching algorithm may analyze the time spread of the particular raw data set to validate that the time span of the five chosen data points does not exceed a predetermined limit, e.g., a constellation geometry based limit. If this limit is not exceeded, then a further inter-element time analysis may be performed to further validate the set. This inter-element time analysis may also be constellation site geometry dependent.

Matched sets may be concatenated into a file that becomes a track file for an aircraft ID. The track file may thus be a flight profile of this aircraft as it flew through the purview (i.e., coverage area/volume) of the AGHME constellation 100. These track files may then be fed to the mathematical model (FIG. 4) for that constellation 100, which may then turn these matched sets into geometric height values for that airframe (as will be understood by one of ordinary skill in the art). These geometric height values may be then further massaged into pressure altitudes by utilizing a series of complex meteorological functions, as also will be understood by one of ordinary skill in the art. The pressure altitudes may then be utilized to compute a altimetry system error (ASE) for that airframe, utilizing known algorithms.

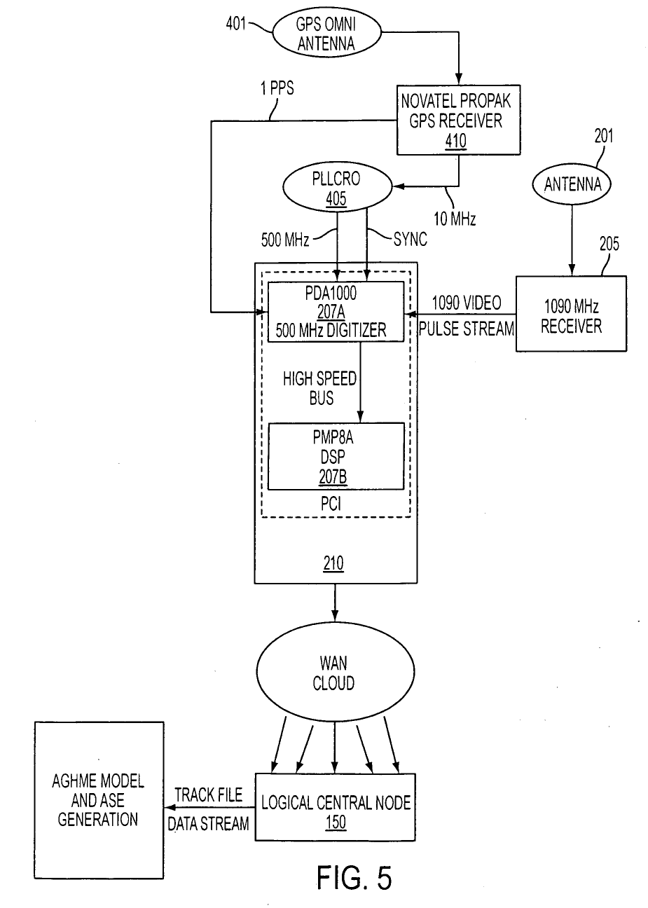

FIG. 5 depicts another example embodiment 500 in which the counter/latch timestamp board 401 may be omitted. That is, in this embodiment the timestamp subsystem may include the GPS receiver 410, the PLLCRO 405, and the digitizer 207A, but not timestamp board 401. Timestamp board 401 can be omitted because, instead of a free-running counter, this example embodiment may be configured to take Universal Coordinated Time (UTC) (i.e., exact time of day) from the GPS receiver 410 and, as one example, compute a 500 MHz count that normally would have been in the counter 415. That is, by assuming that the counter 415 started at midnight when the count would be zero, the computed count (derived from the UTC) and the actual counter count (provided by counter 415 in the previous example embodiment) may be exactly the same.

Thus, the embodiment of FIG. 5 may be characterized as a real-time system in which each element 105A-105E may take a snapshot of the 1090 MHz environment on any agreed to Universal Coordinated Time (UTC) one second periodic rate. The embodiment of FIG. 5 may provide much more accurate/stable time-stamping than the previously-described counter embodiment, i.e., may be as accurate as the variance in 1 PPS leading edges at each of the element 105A-105E locations. In one experimental setup, a maximum variation between element 105A-105E locations was advantageously, only 10-12 nS.

The advantages gained by the example embodiment of FIG. 5 are numerous.

First, the most error prone part of the prior example embodiment of FIG. 4 is the counter/latch timestamp board 401. This is due to its sensitivity to both noise and temperature variations occurring in the board's environment. In the realm of temperature sensitivity, it is the latching mechanism 420 (FIG. 4) that latches the free running count when requested by a trigger in signal 462. This latching must be done in a one nanosecond that the counter 415 is quiescent between counts. If any of the edges are unstable, a misread may result and a bogus time base may thus be obtained for that 1 second time sample. Such errors, i.e., incorrect count, may be observable only by post-analysis of the data sets, and again, may represent an unacceptable level of error in some locating arrangements.

In contrast, in the embodiment of FIG. 5, no instantaneous or accumulative counter error is allowed into the system, because the base time of the 1-second sample set is computed (e.g., for each extracted message) from the UTC time of day (derived from the GPS receiver), and thus is always correct. Thus, in effect, FIG. 5's “counter” may be incorporated into the digitizer 207A and based upon the 500 MHz reference frequency. Code residing in the DSP 207B may, for example, count how many clocks in from the base time at which a Mode S message starts and may add this offset to the base time which then provides the time of arrival of that message at that element 105. This technique may even correct for problems in the GPS training algorithm, since every new sample time is computed independently, and is not acquired from a counter that would have the error resident in the running count.

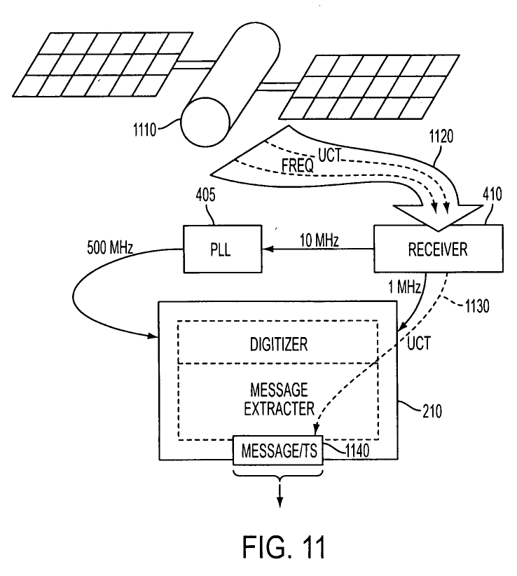

FIG. 11 is a simplistic diagram used to again make clear one important feature of the present invention. More particularly, FIG. 11 illustrates an example orbital satellite entity 1110 (shown as a single satellite for simplicity), digitizer 210, PLL 405 and receiver 410. Representative arrow 1120 is used to representatively show that a download from the orbital satellite entity 1110 includes both a frequency signal component (long/short dashed line) and a universal coordinated time (UTC) component (short dashed line). As mentioned previously, the frequency component is used to lock to the orbital satellite entity's frequency and ultimately derive the 1 PPS, 10 MHz and 500 MHz signals in synchronism with each other. More importantly, the UTC component is captured by the receiver, and a corresponding UTC output from the receiver is ultimately used as an entirety of, or at least a component of, a UTC-based time-stamp TS which is applied to, or corresponded with, each message 1140. Such use of UTC as part of the time-stamp is advantageous in that the UTC supplied and used from the orbital satellite entity is a universal real-time which is substantially consistent between the elements 105A-105E. That is, such UTC, in effect, is a real time (as opposed to a relative time) at each of the elements 105A-105E.

UTC data supplied from the orbital satellite entity and/or used for the message's time-stamp may be of any form. For example, the UTC may be expressed in the form of year:day:hour:minute:second or any portion thereof. Alternatively, the UTC may be expressed as the total number of seconds (or sub-seconds) which have occurred since the occurrence of a predetermined time (e.g., midnight).

FIG. 6 shows one example hardware interconnect diagram of the different sub-systems that may form an AGHME element 105. This diagram epitomizes the simplicity of the system design. By adhering to the FAA's philosophy of off-the-shelf solutions and the evolution (in later embodiments) to eliminate the in-house built time stamp board circuitry, the FIG. 6 system design is very simple to construct and interconnect together. The diagram illustrates that a half dozen interconnect cables to the already described sub-systems makes a -working AGHME element. All that remains needed, may be appropriate code that harmonizes this disjointed set of hardware into a homogonous system that performs the end-state functionality of an AGHME element.

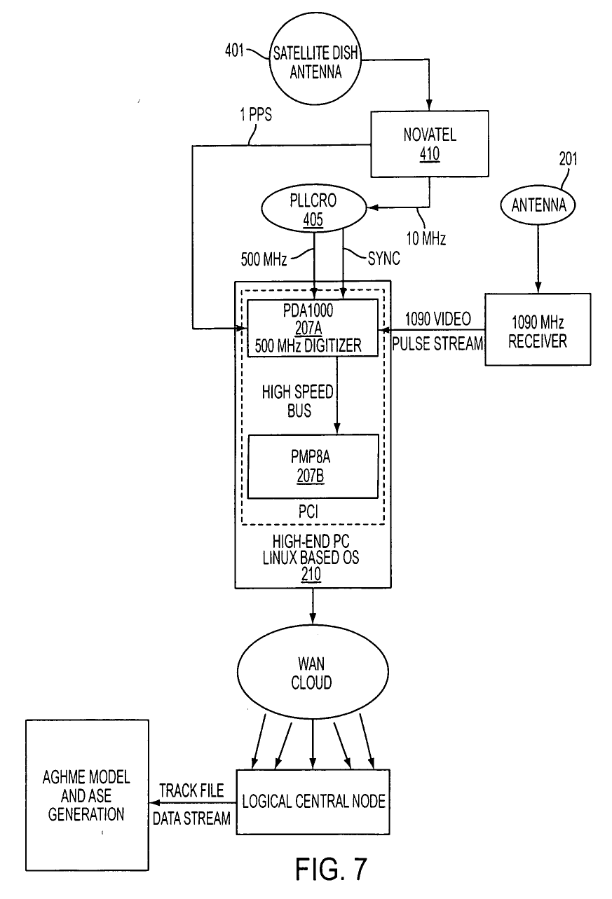

FIG. 7 depicts another example embodiment of the time base sub-system which may further greatly enhance accuracy. From a hardware point of view the change is fairly simple to implement. The GPS omni antenna 401 is replaced by a satellite dish. The firmware in the receiver may have to be replaced with a new algorithm to discipline the local 10 MHz reference frequency. This algorithm may allow for the appropriate training rate for the new signal set utilized from the geosynchronous satellite. Finally, a new code sequence may have to be placed in the tsproc application to accommodate proper programming of the GPS receiver to operate in this new mode of operation.

When this is accomplished, the uncertainty error on the 1 PPS signal in one experimental set-up, significantly improved from an original 10 to 12 nanoseconds, down to under 5 nanoseconds of uncertainty. This gain in performance is due to a number of circumstances that will be described immediately below.

First and foremost is the very essence of using a satellite dish. The heart of GPS reception is the reconstruction of a local frequency standard that is driven in to unison with the satellite based counterpart. In order to achieve this, the frequency is “reconstructed” in the local GPS receiver. This is not perfectly done because of the low level signal that the local receiver obtains from the GPS community satellites.

There are a considerable number of “dropouts” that make the locally produced frequency less than perfect. In the preferred embodiment described here this problem is greatly reduced because of the introduction of the satellite dish looking at a non-moving target. A much higher signal to noise figure is achieved which leads to a much better rendition of the 10 Mhz frequency standard.

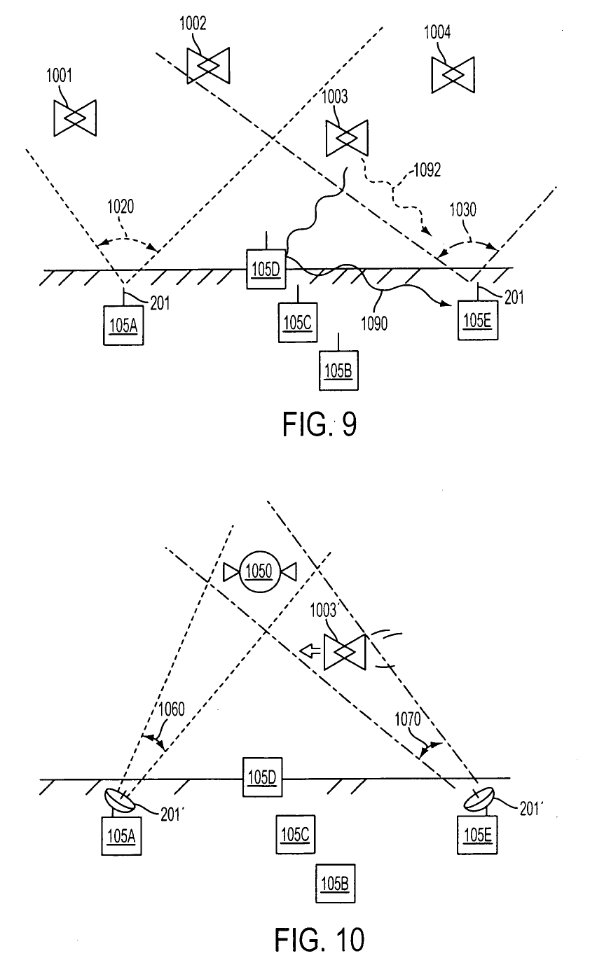

More particularly, attention is directed to FIG. 9, which illustrates an example arrangement of the earth-fixed elements 105A-E, and a plurality of orbital (e.g., GPS) satellites 1001-1004 (i.e., orbiting above the earth). Only two of the elements 105A and 105E, and an example four orbital satellites 1001-1004, will be discussed for simplicity of discussion. Further, the object (e.g., aircraft) to be located/tracked is omitted for simplicity of illustration. Shown are antennas 201 with respect to the elements 105A and 105E. Each of such antennas may have a broad cone of reception (shown representatively by dashed cone/arc 1020 (with respect to the element 105A) and long/short dashed cone/arc 1030 (with respect to the element 105E).

Note that the dashed cone of reception 1020 can sight and receive signals from a first subset, i.e., only two of the orbital satellites 1001-1002, while the long/short dashed cone of reception 1030 can sight and receive signals from a differing subset, i.e., three of the orbital satellites 1002-1004. Because the respective Novatel receivers (not shown in FIGS. 9 or 10) of the elements 105A and 105E utilize signals from differing orbital satellite subsets, there may result a discrepancy (i.e., difference) between resultant relative clocks derived at the respective elements 105A and 105E.

As another source of error, the broadly-sighting antenna 201 of one (or more) of the elements (e.g., 105E) may erroneously utilize an indirect (reflected) signal 1090, instead of a direct signal 1092, from one of the orbital satellites 1003. Again, such may result a discrepancy (i.e., difference) between resultant relative clocks derived at the respective elements 105A and 105E.

A dish-based system may avoid such potential problems. More particularly, FIG. 10 illustrates an example dish-based system. Shown is first type of orbital (e.g., wide augmentation area system (WMS)) satellite, which is a geosynchronous or geostationary satellite. Again, only two of the elements 105A and 105E will be discussed for simplicity of discussion, and the object (e.g., aircraft) to be located/tracked is omitted for simplicity of illustration. Shown are dishes 201′ with respect to the elements 105A and 105E. Each of such dishes may have a narrow cone of reception (shown representatively by dashed cone/arc 1060 (with respect to the element 105A) and long/short dashed cone/arc 1070 (with respect to the element 105E).

Note that both of the narrow cones of reception 1060 and 1070 are locked to sight the geosynchronous or geostationary satellite 1050. Accordingly, since the FIG. 10 elements 105A and 105E utilize exactly the same satellite signal for frequency locking and/or UTC information, such elements 105A and 105E avoid the above-mentioned (FIG. 9) differing subset problems/errors, and frequencies and UTC times can be obtained at the respective elements 105A and 105E which are more closely matched with each other. That is, there is a significant improvement in accuracy.

In addition, by having a narrow cone of reception, the FIG. 10 elements 105A and 105E better avoid the above-mentioned (FIG. 9) reflection problems/errors, and frequencies and UTC times can be obtained at the respective elements 105A and 105E which are more closely matched with each other. Again, there is a significant improvement in accuracy.

In the event that FIG. 10's first type of orbital (e.g., WAAS) satellite 1050 is not configured to supply the UTC download, it is noted that the example FIG. 10 arrangement may be adapted such that the elements 105A-105E also utilize a second type of orbital (e.g., GPS) satellite 1003′ to download the UTC. For example, whereas the first type of orbital (e.g., WAAS) satellite 1050 is geosynchronous or geostationary, the second type of orbital (e.g., GPS) satellite 1003′ may not be (i.e., it may drift slowly across the sky. During times when the second type of orbital (e.g., GPS) satellite 1003′ passes through the narrow cone of reception 1070, the UTC may be downloaded from such passing satellite. Alternatively, the element (e.g., 105E) may be supplemented (if necessary) with a differing type of antenna (in addition to the dish 201′) for receiving the UTC download from the passing satellite.

In beginning to conclude, at least a portion (if not all) of the present invention may be practiced as a software invention, implemented in the form of one or more machine-readable medium having stored thereon at least one sequence of instructions that, when executed, causes a machine to effect operations with respect to the invention. With respect to the term “machine”, such term should be construed broadly as encompassing all types of machines, e.g., a non-exhaustive listing including: computing machines, non-computing machines, communication machines, etc. With regard to the term “one or more machine-readable medium”, the sequence of instructions may be embodied on and provided from a single medium, or alternatively, differing ones or portions of the instructions may be embodied on and provided from differing and/or distributed mediums. A “machine-readable medium” includes any mechanism that provides (i.e., stores and/or transmits) information in a form readable by a machine (e.g., a processor, computer, electronic device). Such “machine-readable medium” term should be broadly interpreted as encompassing a broad spectrum of mediums, e.g., a non-exhaustive listing including: electronic medium (read-only memories (ROM), random access memories (RAM), flash cards);

magnetic medium (floppy disks, hard disks, magnetic tape, etc.); optical medium (CD-ROMs, DVD-ROMs, etc); electrical, optical, acoustical or other form of propagated signals (e.g., carrier waves, infrared signals, digital signals); etc.

Method embodiments may be emulated as apparatus embodiments (e.g., as a physical apparatus constructed in a manner effecting the method); apparatus embodiments may be emulated as method embodiments. Still further, embodiments within a scope of the present invention include simplistic level embodiments through system levels embodiments.

In concluding, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, -it is submitted that it is within the purview of one skilled in the art to effect such feature, structure, or characteristic in connection with other ones of the embodiments and/or components. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc. Further, unless indicated otherwise, any of the specific procedures may be effected in real-time during operation of any apparatus and/or method.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A data-gathering unit for gathering data for determining a location of an object, comprising:
a receiver to receive predetermined data from the object, and a universal coordinated time (UTC) data from an orbital system, and to time-stamp sub-portions of the predetermined data using the UTC derived from the orbital system as a base time.

2. The data-gathering unit as claimed in claim 1, wherein the location is a three-dimensional location.

3. The data-gathering unit as claimed in claim 1, wherein the object is a moving object.

4. The data-gathering unit as claimed in claim 1, wherein the orbital system is at least one of a geographical positioning system (GPS) satellite system and a wide area augmentation system (WAAS) satellite system.

5. The data-gathering unit as claimed in claim 1, wherein the orbital system includes a wide area augmentation system (WAAS) satellite system, and wherein the receiver includes a dish-antenna arranged to receive data from the WAAS satellite system.

6. The data-gathering unit as claimed in claim 1, wherein the receiver is to receive a standard frequency oscillation from the orbital system, and to produce a plurality of frequency oscillation clocks different in frequency from, but synchronized with, the standard frequency oscillation.

7. A system for determining a location of an object, comprising:
a plurality of geographically-distributed data-gathering units for gathering data for determining the location of the object, with each data-gathering unit including:
a receiver to receive predetermined data from the object, and a universal coordinated time (UTC) data from an orbital system, and to time-stamp sub-portions of the predetermined data using the UTC derived from the orbital system as a base time.

8. The system as claimed in claim 7, wherein the location is a three-dimensional location.

9. The system as claimed in claim 7, wherein the object is a moving object.

10. The system as claimed in claim 7, wherein the orbital system is at least one of a geographical positioning system (GPS) satellite system and a wide area augmentation system (WAAS) satellite system.

11. The system as claimed in claim 7, wherein the orbital system includes a wide area augmentation system (WMS) satellite system, and wherein the receiver includes a dish-antenna arranged to receive data from the WMS satellite system.

12. The system as claimed in claim 7, wherein the receiver is to receive a standard frequency oscillation from the orbital system, and to produce a plurality of frequency oscillation clocks different in frequency from, but synchronized with, the standard frequency oscillation.

13. The system as claimed in claim 7,
wherein at least some of the data-gathering units comprising a communication unit to communicate the time-stamped sub-portions of the predetermined data to a predetermined master receiver; and
where the predetermined master receiver including:
a set-matching unit to determine sets of the time-stamped sub-portions from differing ones of the data-gathering units, which are related to one another as being a same portion of the predetermined data received redundantly at the differing ones of the data gathering units; and,
a location determining unit to determine the location of the object using the sets of the time-stamped sub-portions.

14. An aircraft altitude determining system for determining an altitude of an aircraft, comprising:
a plurality of geographically-distributed data-gathering units for gathering data for determining the altitude of the aircraft, with each data-gathering unit including:
a receiver to receive predetermined data from the aircraft, and a universal coordinated time (UTC) data from an orbital system, and to time-stamp sub-portions of the predetermined data using the UTC derived from the orbital system as a base time.

15. The system as claimed in claim 14, wherein the aircraft is a moving aircraft.

16. The system as claimed in claim 14, wherein the orbital system is at least one of a geographical positioning system (GPS) satellite system and a wide area augmentation system (WAAS) satellite system.

17. The system as claimed in claim 14, wherein the orbital system includes a wide area augmentation system (WMS) satellite system, and wherein the receiver includes a dish-antenna arranged to receive data from the WMS satellite system.

18. The system as claimed in claim 14, wherein the receiver is to receive a standard frequency oscillation from the orbital system, and to produce a plurality of frequency oscillation clocks different in frequency from, but synchronized with, the standard frequency oscillation.

19. The system as claimed in claim 14,
wherein at least some of the data-gathering units comprising a communication unit to communicate the time-stamped sub-portions of the predetermined data to a predetermined master receiver; and
where the predetermined master receiver including:
a set-matching unit to determine sets of the time-stamped sub-portions from differing ones of the data-gathering units, which are related to one another as being a same portion of the predetermined data received redundantly at the differing ones of the data gathering units; and,
a altitude determining unit to determine the altitude of the aircraft using the sets of the time-stamped sub-portions.
